(19) United States
(12) Patent Application Publication
(10) Pub. No.: US 2005/0035481 A1
(43) Pub. Date: Feb. 17, 2005

(54) Process to sinter ultra high molecular weight polyethylene

(76) Inventors: Sanjay Rastogi, Eindhoven (NL); Lada Kurelec, Weert (NL)

Correspondence Address: Richard A Steinberg;Pillsbury Winthrop, P O Box 10500, McLean, VA, 22102, US

(21) Appl. No.: 10/492,416

(22) PCT Filed: Oct. 10, 2002
(86) PCT No.: PCT/NL02/00649

(30) Foreign Application Priority Data
Oct. 12, 2001 (EP) 01203865.9

(51) Int. Cl. B27N 3/02

(52) U.S. Cl. 264/127

(57) ABSTRACT

The current invention is directed to a process to sinter an ultra high molecular weight polyethylene (UHMW-PE) having a weight average molecular mass of more than 1.10⁶ g/mol, wherein a disentangled UHMW-PE is heated to a temperature above its equilibrium melting temperature at a pressure below 20 MPa.

The invention relates to a process to sinter an ultra high molecular weight polyethylene (UHMW-PE) having a weight average molecular weight of more than 1.10⁶ g/mol.

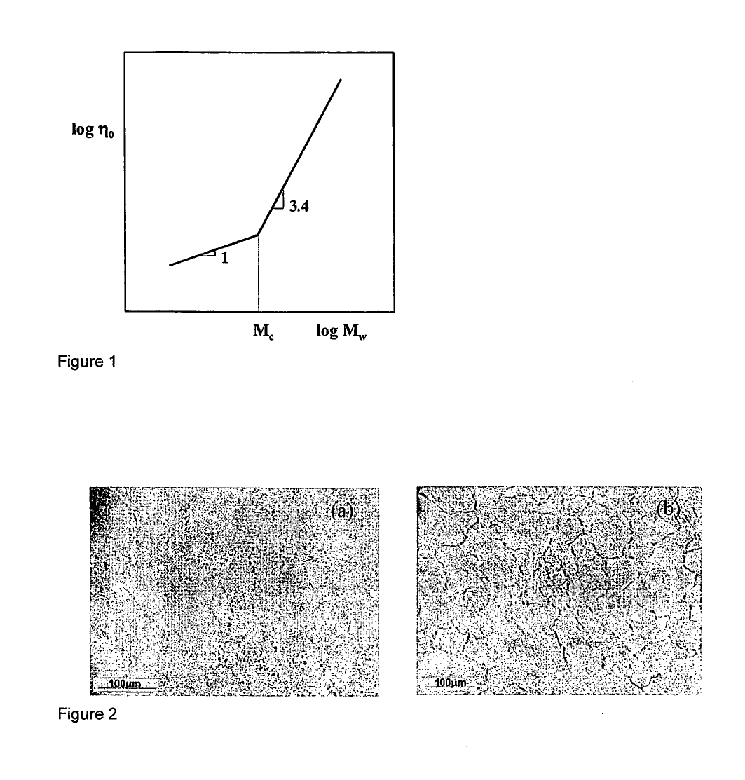

Processing of synthetic polymers is often a compromise between the ease of processing and the desired product properties. Processing routes conventionally applied in polymer industry are injection moulding, extrusion and blow moulding. All these routes are starting from a melt and the molten state is mostly affected by changes in the molecular weight. This is given by the universal relationship between the zero shear viscosity and the molecular weight as given in FIG. 1, presenting the universal relationship between the zero shear viscosity (η₀) and the weight average molecular weight (M_{w}). M_{c} is a critical molecular weight, which is related to the lower limit where a polymer chain is able to entangle.

It can be seen from FIG. 1 that for relatively low molecular weight melts (M_{w}<M_{c}), there is a simple proportionality between the zero-shear viscosity and the molecular weight, while for melts having a high molecular weight (M_{w}>M_{c}), the dependence becomes rather strong (η₀˜M_{w}^{3.4}). The difference is related to the ability of long polymer chains to entangle, which imposes a restriction to an easy flow of the melt. On the other hand, the motion of a polymer chain within a highly entangled melt is described by the reptation model, introduced by de Gennes in J. Chem. Phys. 1971, 55, 572. In this model a polymer chain within a melt moves worm-like through a virtual tube, which consists of entanglements formed by neighbouring polymer chains. The time needed for the polymer chain to renew its tube, i.e. to change its position within the melt (τ₀), is also highly dependent on the molecular weight (τ₀˜M_{w}³). This time (τ₀) is hereinafter referred to as reptation time. These fundamental restrictions make high molecular weight polymers rather intractable via conventional processing routes. On the other hand, final properties like toughness, strength and wear increase with molecular weight. Superior properties are necessary to meet requirements for a highly demanding application. An illustrative example showing a discrepancy between intrinsic properties related to high values of molecular weight, and insufficient product performance due to difficulties in processing is found in ultrahigh molecular weight polyethylene (UHMW-PE). UHMW-PE is a linear grade of polyethylene, just like HDPE, but possessing a weight average molecular weight of at least 1·10⁶ g/mol (according to ASTM D4020). Preferably the UHMW-PE has a weight average molecular weight of at least 3·10⁶ g/mol. Due to its intrinsically good wear and friction characteristics originating from the high molecular weight, it has been selected as the material of choice in highly demanding applications, like hip and knee joint prostheses. In both types of the joints, UHMW-PE is used as an interface between the human bone and a metal or ceramic part which slides against the polyethylene component during normal gait.

It has been however recognised that such a construction of a joint prosthesis does not meet long lifetime requirements and in most cases it is the polyethylene part that fails. In the case of hip prosthesis hundreds thousands of (sub)-micron particles of the UHMW-polyethylene are released upon each gait, leading to severe body reaction and ultimately loosening of the joint. On the other hand, the polyethylene tibial component within the knee prosthesis undergoes macroscopic failure, due to cyclic loading experienced by the knee joint.

Due to the intractability of this material via conventional routes, UHMW-PE is usually processed via compression moulding or ram-extrusion into simple shapes, like rods, plates or sheets, which are subsequently machined into the desired products. It has been found that all the products of UHMW-PE possess residues of the original powder particles (usually referred to as grain boundaries or fusion defects). These flaws in the material are a consequence of a long reptation time needed for the molecular chain to cross from one powder particle to another. FIG. 2 exhibits a light microscopy picture of thin sections cut from (a) a completely new hip cup and (b) a hip cup retrieved from a human body after 7 years. Grain boundaries seem to become more pronounced after usage, indicating that the grain boundaries are weak points in the material.

Fusion defects within the material have been always considered one of the reasons for an insufficient lifetime of artificial joints. Therefore, improvement of the processability of this material is of the utmost importance in order to meet the ultimate properties of UHMW-PE, like crack-resistances, anticipated for such high values of the molecular weight.

In the present invention said improvement has been obtained by a process to sinter an ultra high molecular weight polyethylene (UHMW-PE) having a weight average molecular mass of more than 1.10⁶ g/mol, wherein a disentangled UHMW-PE powder is heated to a temperature above its equilibrium melting temperature at a pressure of at least 1 MPa.

A major breakthrough in the processing of an UHMW-PE was achieved in the early nineteen hundred and eighties when solution-spinning of UHMW-PE into high modulus/high strength fibres has been developed. In the process described in UK Patent 2,051,661, UHMW-PE is dissolved at elevated temperatures, and the semi-dilute solution is spun into filaments, which are subsequently drawn to high drawing ratios (above 30), at temperatures close to but below the melting point. Thus obtained fibres possess a tensile strength of 3 GPa and a Young's modulus above 100 GPa. An identical polymer sample crystallised from the melt could not be drawn more than 5-7 times, resulting in fibres possessing poor mechanical properties. These results suggest that the density of the entanglements plays a prominent role in the process of drawing and obtaining fully aligned chains in the drawing direction. In the case of melt crystallized UHMW-PE, entanglements are trapped upon crystallization and they limit the extent to which the chains can be drawn. On the other hand, crystallization of long molecular chains from the semi-dilute solutions leads to a much less entangled system, which enables the drawing of these materials at a temperature below the melting temperature. This means that it is possible to reduce the initial number of entanglements, which are the biggest limitation in the melt processing of UHMW-PE, as discussed above. It has always been believed that once a disentangled state of UHMW-PE has been achieved, the formation of entanglements within the melt will be very slow, due to long reptation time, and consequently one would be able to benefit from a disentangled state during processing. Experimental results however showed that highly disentangled solution crystallized films of UHMW-PE, drawable below the melting temperature, loose their drawability immediately upon melting. This phenomenon has been associated with the phenomenon of “chain explosion”, experimentally assessed by Barham and Sadler in Polymer 1991, 32, 939. With the help of in-situ neutron scattering experiments they observed that the chains of highly disentangled folded chain crystals of UHMW-polyethylene increase the radius of gyration instantaneously upon melting. Consequently the polymer chains entangle immediately upon melting, which causes the sudden loss in drawability once the sample has been molten. These results show that the fundamental restrictions related to the strong dependence of the zero-shear viscosity and the molecular weight can not be easily overcome. Simple disentanglement of the chains prior to melting will not lead to a less entangled melt and accordingly it cannot be used to improve the melt processing of UHMW-PE.

UHMW-PE is normally obtained in the form of a fine powder, usually synthesised with the help of Ziegler-Natta or single site catalyst system, at temperatures below the crystallization temperature of the polymer chain. These synthesis conditions force the molecular chains to crystallize immediately upon their formation, leading to a rather unique morphology which differs substantially from the one obtained from the solution or the melt. The crystalline morphology created at the surface of a catalyst will highly depend on the ratio between the crystallization rate and the growth rate of the polymer. Moreover, the temperature of the synthesis, which is in this peculiar case also crystallization temperature, will highly influence the morphology of the obtained UHMW-PE powder.

One of the most prominent features of a disentangled UHMW-PE powder is its ability to flow below the α-relaxation temperature, as described by Smith, P., Chanzy, H. D. and Rotzinger, B. P. in J. Mater. Sci. 1987, 22, 523. This extraordinary property of this so-called nascent powder, used by Smith et. al., is associated with the reduced number of entanglements. The extent to which the number of entanglements is reduced in a nascent powder is highly dependent on the synthesis conditions (like synthesis temperature and monomer pressure), as well as the type of the catalyst.

Another way to obtain a disentangled powder is via the mobile hexagonal phase, as described by Rastogi et. al. in Macromolecules 1998, 31, 5022-5031.

The objective of this invention is to find a novel route to process UHMW-PE into homogeneous products in order to improve its performance in high demanding applications like hip and knee artificial joints.

According to the invention this objective is achieved in a process to sinter an UHMW-PE with a weight average molecular weight of more than 1.10⁶ g/mol, wherein a disentangled UHMW-PE powder is heated to a temperature above its equilibrium melting temperature at a pressure above 1 MPa.

With the process of the invention a completely homogeneous grain boundary free UHMW-PE product can be obtained.

A method suitable to qualitatively assess the extent of initial (dis)entanglement of the nascent material is simple compaction of the powder at 50° C. at a pressure above 1 MPa, and subsequent observation of the transparency of the obtained film (See the article of Rotzinger et.al. in Polymer, 1989, vol, 30; pages 1814 ff.). An UHMW-PE powder resulting in a transparent film after pressing at 50° C. is hereinafter referred to as a disentangled UHMW-PE powder.

For the equilibrium melting temperature of disentangled UHMW-PE, reference is made to PE in Wunderlich, B. et al. in ATHAS databank http://web.utk.edu/˜athas. In this publication said equilibrium temperature is indicated to be 414.6 K for the crystalline product.

The process according to the invention is preferably performed in the sense, that the disentangled UHMW-PE powder is heated to a temperature between 425 and 600 K. The pressure at which the sintering process takes place is at least 1 MPa. The upper limit of the pressure is not critical. Based on mechanical constraints on high pressure equipment, preference is given to a pressure between 1.5 and 100 MPa; more preferred a pressure of or below 20 MPa is used. Preferred is a process to sinter an ultra high molecular weight polyethylene (UHMW-PE) having a weight average molecular mass of more than 1.10⁶ g/mol, wherein a disentangled UHMW-PE powder is heated to a temperature above its equilibrium melting temperature at a pressure below 20 MPa.

Smith, P., et al. extensively describe in J. Mater. Sci. 1987, 22, 523, how to make a disentangled UHMW-PE. As a catalyst a Ziegler-Natta type of catalyst can be used. Preferably a single site type catalyst is used. Herewith a higher degree of disentanglement can be obtained within the range of UHMW-PE powders with an ability to flow below the α-relaxation temperature.

The invention relates therefore to a process with three essential elements:
use of a disentangled UHMW-PE powder
sintering above the equilibrium melting temperature
at a pressure of at least 1 MPa.

The invention further relates to a shaped part made with the process of the invention. Examples of parts for which the process of the invention forms an advantageous manufacturing method are artificial knees prosthesis and artificial hip joints. With the process of the invention completely grain boundary free parts can be made, which is an advantage in highly abrasive and fatigue subjected environments like hip joints and knees.

The invention further will be elucidated with some Examples and comparative experiments.

### EXAMPLE I, Comparative Experiments A and B

Three different types of nascent powders of UHMW-PE have been used. They differ in synthesis conditions and catalyst type. Two different grades of Ziegler-Natta catalyst have been used.

As a representative of a commercial grade of a nascent powder the results on 1900CM grade of Montell are used, though similar results have been obtained for different commercial grades of UHMW-PE powders, like those of DSM and Ticona.

Laboratory scale Ziegler Natta based grade of UHMW-PE powder (ES 1733/35) used in this study was provided by DSM. This powder has been synthesised using a moderately active catalyst at 50° C.

The third powder that has been investigated was a homogeneous metallocene based grade of UHMW-PE (BW 2601-95), also provided by DSM. Molecular characteristics of these powders are given in Table 1.

TABLE 1
Details of the nascent UHMW-PE powder grades

| Example/ | | | | | | |
|---|---|---|---|---|---|---|
| Comp. Exp. | Grade name | Producer | Com./lab. | M_{w} | M_{w}/Mₙ | T_{synthesis} |
| A | 1900CM | Montell | commercial | 4.54 · 10⁶ g/mol* | — | 60-80° C. |
| B | ES1733/35 | DSM | laboratory | 3.6 · 10⁶ g/mol | 5.6 | 50° C. |
| | | | scale | | | |
| I | BW2601-95 | DSM | laboratory | 3.6 · 10⁶ g/mol | 2.9 | 25° C. |
| | | | scale | | | |

*Info provided by Montell: M_{w} = 5.4 · 10⁴ (ηₒ)^{1.36}; ηₒ is the intrinsic viscosity.

All the powders were placed between aluminum foils and compacted at 50° C. at a pressure of 200 MPa. The coherence of the resulting films was determined by macroscopic observation; the transparancy was determined visually. After compaction the metallocene based powder (Example I) showed a nearly transparent film or in other words: was disentangled. In the case of Ziegler-Natta based laboratory scale material (comparative experiment A) a certain coherence of the powder could be obtained, but this film was not transparent at all. On the other hand no observable coherence could be achieved upon compaction of the commercial grade of nascent powder at 50° C. (comparative experiment B). The powder exhibited no coherence as it stayed fully “powdery”.

These results can be explained by differences in the catalyst type as well as in the synthesis conditions. The major difference between a supported Ziegler-Natta and a homogeneous metallocene catalyst system used in Table 1 is that the former one possesses a higher density of active sites compared to the latter. In case of the Ziegler-Natta catalyst system, polymer chains will grow relatively close to each other which will enable them to “meet” and subsequently entangle. The extent to which the chains can entangle depends on the catalyst activity and the synthesis conditions (like temperature, monomer pressure). Commercial grades are known to be synthesised with the help of highly active catalysts having high yields. In that case huge quantities of the polymer are produced per gram of the catalyst (20-100 g polymer/g catalyst), leading to a higher number of initial entanglements (comparative experiment A). In the case of the laboratory scale samples which are synthesised with the help of a moderately active catalyst, the chains will grow slower and further away from each other, leading to a less entangled system (comparative experiment B). On the other hand, for the single-site metallocene catalyst, the active sites are dispersed in the reaction medium and only one polymer chain can be produced per active site. That means that the polymer chains grow far away from each other, not having strong probability of entangling. In this case the possibility of formation of an (almost) fully disentangled state becomes feasible (Example I).

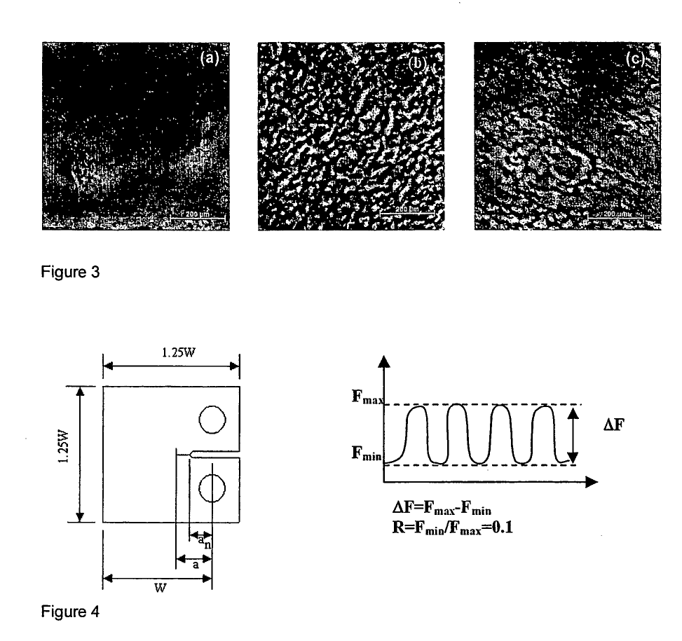

FIG. 3 shows the results of the sintering of the three different powder grades after compaction at 20 MPa and a temperature of 180° C. for a period of 10 minutes: (a) Metallocene grade, (b) Laboratory scale Ziegler-Natta grade, (c) Commercial Ziegler-Natta grade.

It can be seen that in the case of the metallocene based powder (Example I), full fusion of the powder particles occurred on compacted products, made from Ziegler-Natta based powders, both laboratory and commercial one, still exhibit residues of the original powder particles, as usually observed in the UHMW-PE products available in the market (comparative experiments A and B).

### EXAMPLE II and Comparative Experiment C

Crack propagation measurements were performed on fused UHMW-PE samples, according to ASTM E 647-93. The most prominent requirement for standard measurements of crack propagation is to keep the ratio between minimum the (Kₘᵢₙ) and the maximum stress intensity (Kₘᵢₙ), i.e. R=Kₘᵢₙ/Kₘₐₓ, the same for all different samples, while ΔK keeps increasing as the crack starts to grow. This has been fulfilled in two different ways.

In the first set of experiments the maximum force (Fₘₐₓ) during cycling loading was kept constant for the different samples, which means that all the parameters (ΔF=Fₘₐₓ−Fₘᵢₙ, R and frequency) were kept constant. In the second set of the experiments, Fₘₐₓ has been adjusted so that the crack propagation rate becomes approximately the same for each sample. The later experimental approach is usually used in literature when discussing crack propagation results on UHMW-PE.

Compact tension (CT) specimens as shown in FIG. 4 were used for the crack propagation measurements. FIG. 4 shows a schematic diagram of the compact tension specimen and the definition of the stress ratio for fatigue testing.

The dimensions of the specimen were as follows: W=32 mm, aₙ=6.4 mm and thickness (B) was 6±0.5 mm. Each sample has been pre-cracked using a sharp razor blade just before the testing (a−aₙ=1±0.2 mm).

The experiments were performed with a MTS 810 Elastomer test system using a sinusoidal wave function at a frequency of 5 Hz. The crack propagation has been followed using an optical objective (10×) on a digital Pixera camera. The relation between the far-field loading and near-tip stress intensity is derived from the fracture mechanics fundamentals, which for the compact tension geometry reads as follows:

$$Δ K = Δ F \cdot \frac{F ( a )}{( B \cdot \sqrt{W} )} \qquad ( 1 )$$

where ΔF is the load amplitude of the fatigue cycle, F(α) is the geometric factor and α is defined as a/W. The geometric factor for compact tension geometry as calculated from the elastic theory is:

$$F ( α ) = \frac{( 2 + α )}{{( 1 - α )}^{1.5}} ( 0.886 + 4.64 α - 13.32 {α}^{2} + 14.72 {α}^{3} - 5.6 {α}^{4} ) \qquad ( 2 )$$

Once the crack starts to propagate, the fatigue crack propagation can be presented with the help of the Paris-Erdogan equation, which implies that the crack propagation rate (da/dN) is only determined by the stress intensity range (ΔK), as given in the equation 3:
da/dN=C·ΔK^{m} (3)
where C and m are material constants.

Paris-Erdogan plots have been used extensively to evaluate crack propagation resistance of different polymer materials. The Paris-Erdogan equation described in “Trans. ASME 1963, 528” suggest that the governing parameter controlling the crack growth is the range of stress intensity (ΔK), which is a measure of the stress distribution at the crack tip. Due to the plastic nature of polyethylene and the accompanying insufficient sample size, the derived values of the stress intensity range do not represent the intrinsic values for the material under investigation, but they are codetermined by the geometry of the compact tension test bar. Consequently when discussing the results, ΔK as calculated from the experimental data will be denominated as ΔK′. It should be noticed that this newly defined value, in a systematic way, is always larger than the intrinsic ΔK value and hence can still be used for comparative purposes, as long as the geometry remains unchanged.

In order to determine the role of grain boundaries in crack propagation resistance of UHMW-PE sintered at 20 MPa and 180° C., a commercial powder of UHMW-PE (GUR 4150 from Ticona), hereinafter referred to as “ref” (comparative experiment C) has been compared with a grain boundary free material, used according to the process of the invention (Example I), hereinafter referred to as “sintered”.

Crack propagation is measured by keeping the ratio between minimum (Kₘᵢₙ) and maximum stress intensity (Kₘᵢₙ), i.e. R=Kₘᵢₙ/Kₘₐₓ, constant for the samples, while ΔK keeps increasing as the crack starts to grow. These experimental requirements can be met in two different ways, either by keeping the maximum force during cycling loading constant for all different samples, or by adjusting the force so that the crack propagation rate becomes approximately the same for each sample. Both types of the experiments have been performed and will be discussed separately.

The crack length versus number of cycles needed for the total failure measured under the constant force is plotted in the FIG. 5. These results are obtained by the experiment where the maximum force during cyclic loading has been kept constant for the different samples. It is obvious from these results that the crack growth in the reference sample is the fastest under the chosen loading conditions. This indicates on the other hand that the fully fused material (from Example I) is more resistant to crack propagation. Hence these results indicate that the presence of grain boundaries plays an important role in the fatigue resistance of UHMW-PE products.

In order to exclude the influence of the crystallinity on the results, the commercial powder of comparative experiment C has been processed under the same condition as the material free of grain boundaries of Example I. Due to the same processing conditions (notably cooling rate), the samples were characterised to have approximately the same crystallinity.

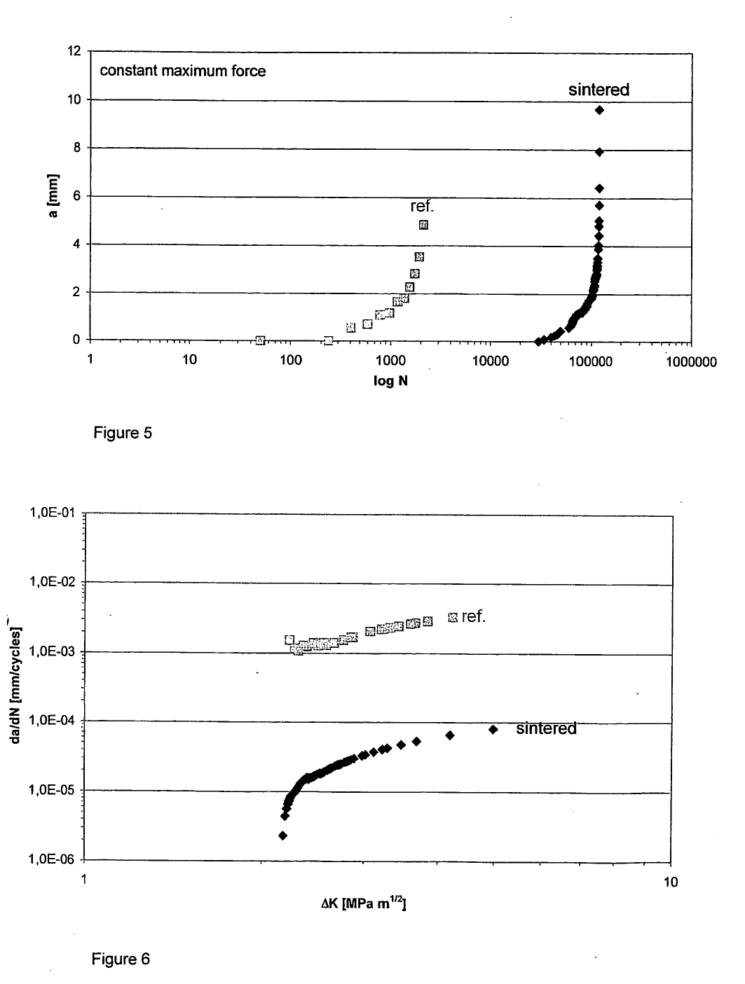

A significant difference in the crack propagation behaviour is shown between the reference sample (still featuring grain boundaries) and the fully sintered sample. For the present set experiments the Paris-Erdogan plot (da/dN vs. ΔK) calculated from the crack propagation data obtained by measurements under constant force, as displayed in FIG. 6, reveals that for the same stress intensity range (ΔK) the crack propagation rate is the fastest for the reference and slowest for the grain boundary free material.

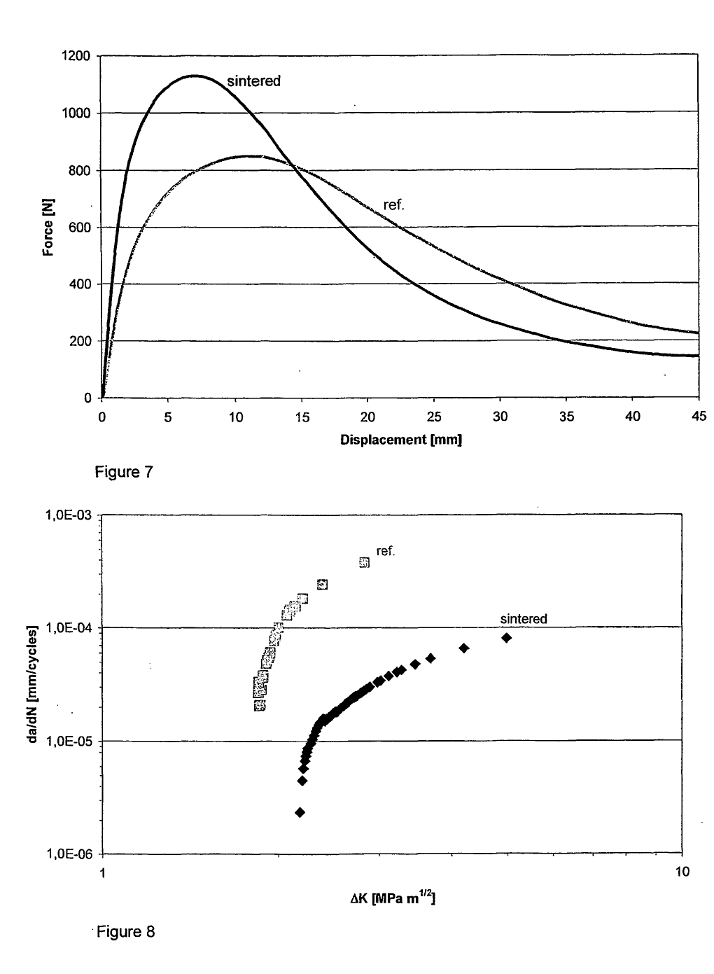

As already mentioned these results have been obtained by keeping all experimental conditions, like Fₘₐₓ, R and frequency constant for the samples. However, one might argue that choosing one value of the maximum force during cyclic loading for the samples is not fully correct. The impact response of these materials is rather different and by choosing one maximum force for the samples, the influence of plasticity, which is anyway very critical, might play a dominant role during fatigue measurements. This has been tested by measuring the response of different UHMW-polyethylene samples on monotonous tensile displacement, which can be regarded upon as a slow impact test. The measurements have been performed on compaction tension test geometry, same as used for the fatigue measurements. The typical force displacement curve for the two UHMW-polyethylene samples under investigation (Example I and comparative experiment C) is given in FIG. 7.

It is generally accepted that at the maximum load, initiation of the crack occurs, which is followed by the catastrophic reduction in the load due to subsequent crack propagation. Since UHMW-polyethylene is a very ductile material, plastic deformation will have a very strong influence on the response of the sample to the monotonous tension, and therefore the maximum load of the curve is not only related to the crack initiation but mostly to conventional yielding. This plot is not meant to characterise the different samples, but rather to emphasise that the fatigue measurements performed at one constant maximum force are fundamentally not fully correct, due to the different plasticity when the selected maximum force is close to or much below the “yield point”. In order to avoid this, a second set of measurements have been performed in such a way that for each sample the maximum force during cyclic loading has been 50% of the maximum load as observed in a monotonous run. By choosing the parameters in this way, the crack propagation rate for each sample was also approximately the same.

FIG. 8 shows the Paris-Erdogan plots calculated from the crack propagation data obtained by measurements performed under the same crack propagation rate. The parameters related to the Paris regime are given in Table 2.

TABLE 2
The parameters of the Paris-Erdogan regime calculated from the plots
expressed in FIG. 8.

| Example/ | | ΔK_{int.} | |
|---|---|---|---|
| Comp. Exp. | Material | [MPa · m^{1/2}] | Slope, m |
| I | Grain boundary free | 2.18 | 3.2 |
| C | Reference | 1.85 | 16.6 |

Because the crack starts to propagate at approximately the same values of da/dN for all different samples, ΔK intercept (ΔKᵢₙₜ) has been also determined from FIG. 8 by extrapolation to da/dN=0 ΔKᵢₙₜ is related to the stress at the tip needed for the crack to start to propagate. Again, if the results for the different UHMW-polyethylene powder samples are compared, the grain boundary free material (Example I) exhibits the highest fatigue resistance. Table 2 shows that the ΔKᵢₙₜ for grain boundary free material (Example I) is 2.18, which is much higher than the values obtained for the reference material (comparative experiment C). Taking these results into account, it can be concluded that the removal of the grain boundaries highly improves the fatigue resistance of UHMW-PE. The superior fatigue behaviour of this material implies that disentangled UHMW-PE powder sintered according to the process of the invention is a good alternative for use of in knee and hip joints.

1. Process to sinter an ultra high molecular weight polyethylene (UHMW-PE) having a weight average molecular mass of more than 1.10⁶ g/mol, wherein a disentangled UHMW-PE is heated to a temperature above its equilibrium melting temperature at a pressure at or below 20 MPa.

2. Process to sinter an ultra high molecular weight polyethylene (UHMW-PE) having a weight average molecular mass of more than 1.10⁶ g/mol, wherein a disentangled UHMW-PE powder is heated to a temperature above its equilibrium melting temperature at a pressure of at least 1 MPa.

3. Process according to claim 1, wherein the disentangled UHMW-PE is heated to a temperature between 425 and 600 K.

4. Process according to claim 1, wherein the disentangled UHMW-PE is heated at a pressure between 1.5 and 100 MPa.

5. Process according to claim 1, wherein the disentangled UHMW-PE is heated at a pressure below 20 MPa.

6. Process according to claim 1, wherein the disentangled UHMW-PE is made with a metallocene catalyst system.

7. Shaped part made with the process according to claim 1.

8. Use of a shaped part according to claim 7 in a highly abrasive environment.

9. Use of a shaped part according to claim 7 in a highly fatigue subjected environment.

10. Use according to claim 8 in an artificial knee prosthesis or an artificial hip joint.

11. Process according to claim 1, wherein the disentangled UHMW-PE is heated to a temperature above 414.6K at a pressure at or below 20 MPa.

12. Process according to claim 11, wherein the disentangled UHMW-PE is heated at a pressure below 20 MPa.
